(19) United States
(12) Patent Application Publication
(10) Pub. No.: US 2004/0098899 A1
(43) Pub. Date: May 27, 2004

(54) Fishing rod for nighttime fishing

(76) Inventor: Chih-Yueh Yeh Yang, Jhonghe City (TW)

Correspondence Address: Chih-Yueh Yeh Yang, P.O. Box No. 6-57, Junghe, Taipei, 235, TW

(21) Appl. No.: 10/704,583

(22) Filed: Nov. 12, 2003

(30) Foreign Application Priority Data
Nov. 22, 2002 (CN) 02289221.4

(51) Int. Cl. A01K 87/00

(52) U.S. Cl. 43/18.1 R

(57) ABSTRACT

A fishing rod for nighttime fishing usage, includes a female ferrule configured on a frontal extremity of a hand grip, and thereby enabled to connect with a male ferrule configured on a tail extremity of a line-support rod. Moreover a plurality of guide rings are fixedly configured on the hand grip and the line-support rod thereof, and a light-emitting area is defined on each location on the fishing rod corresponding to each of the guide rings, thereby achieving effectiveness of being able to identify the fishing rod when using the fishing rod at nighttime from illumination emitting from the light-emitting areas. Moreover, the light-emitting areas are defined with fluorescent paint adhered to external edges of the fishing rod, thereby giving strong brightness to the light-emitting areas. The present invention thus accomplishes practicability, is of economical advantage and provides advancement in fishing rod design.

### BACKGROUND OF THE INVENTION

(a) Field of the Invention

The present invention relates to fishing rods, and more particularly to a fishing rod for nighttime fishing usage. A light-emitting area is defined on each location on the fishing rod corresponding to each of a plurality of guide rings configured on the fishing rod. Furthermore, the light-emitting areas are defined with fluorescent paint adhered to external edges of the fishing rod, thereby giving strong brightness to the light-emitting areas, and thereby achieving effectiveness of being able to identify the fishing rod when using the fishing rod at nighttime from illumination emitting from the light-emitting areas.

(b) Description of the Prior Art

According to a conventional fishing rod designed for nighttime usage, although nighttime luminance is provided, however, structure of light-emitting accessories attached to the conventional fishing rod are complicated or require regular replacement and adjustment, resulting in assemblage of such light-emitting accessories being time-consuming and troublesome, as well as requiring a need for additional expenditure. Furthermore, length of time the light-emitting accessories can provide illumination is comparatively short, and therefore requires frequent replacement with new light-emitting components, causing extreme vexation and wastage to a user. Moreover, brightness of the light-emitting areas provided by the conventional fishing rod is comparatively weak, and therefore unable to provide functionality of accurate identification of the fishing rod when in usage at nighttime. The aforesaid design identifies lack of practicability in the conventional fishing.

Wherefore, technical difficulties present in eliminating the aforesaid shortcomings are those that the inventor of the present invention intends to resolve in disclosures described herein.

### SUMMARY OF THE INVENTION

In light of this, the inventor of the present invention, possessing intrinsic professional accomplishments and technical know-how, as well as having accumulated years of experience in related work, over a course of many trials and improvements perfected the present invention, having a primary objective to provide an improved fishing rod for nighttime fishing usage. Primary structure of the fishing rod according to the present invention comprises a female ferrule configured on a frontal extremity of a hand grip, and thereby enabled to connect with a male ferrule configured on a tail extremity of a line-support rod. Moreover a plurality of guide rings are fixedly configured on the hand grip and the line-support rod thereof, and a light-emitting area is defined on each location on the fishing rod corresponding to each of the guide rings, thereby achieving effectiveness of being able to identify the fishing rod when using the fishing rod at nighttime from illumination emitting from the light-emitting areas. Moreover, the light-emitting areas are defined with fluorescent paint adhered to external edges of the fishing rod, thereby giving strong brightness to the light-emitting areas, and a light-emitting time period of 8 hours, thus achieving functionality of accurate identification of the fishing rod when in use at nighttime and extended light-emitting usage over a long period of time. The present invention thus accomplishes practicability, is of economical advantage and provides advancement in fishing rod design.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view according to the present invention.

FIG. 2 shows an exploded elevational view according to the present invention.

FIG. 3 shows a schematic diagram of an embodiment according to the present invention.

FIG. 4 shows a schematic diagram of an embodiment further depicted according to the present invention.

### DETAILED DESCRIPTION OF THE PREFERRED EMBODIMENTS

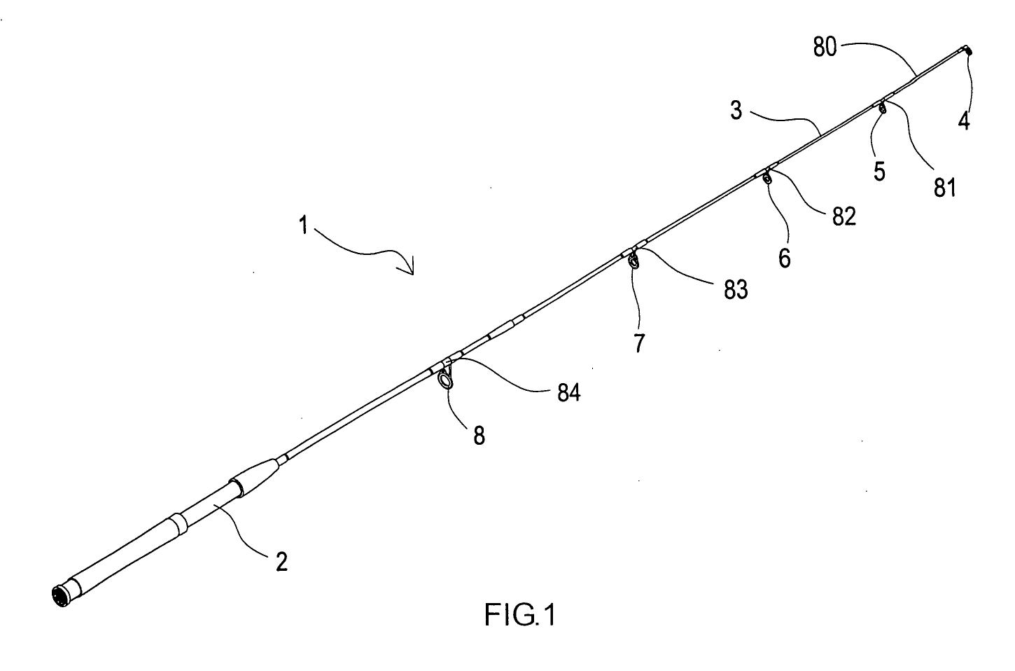

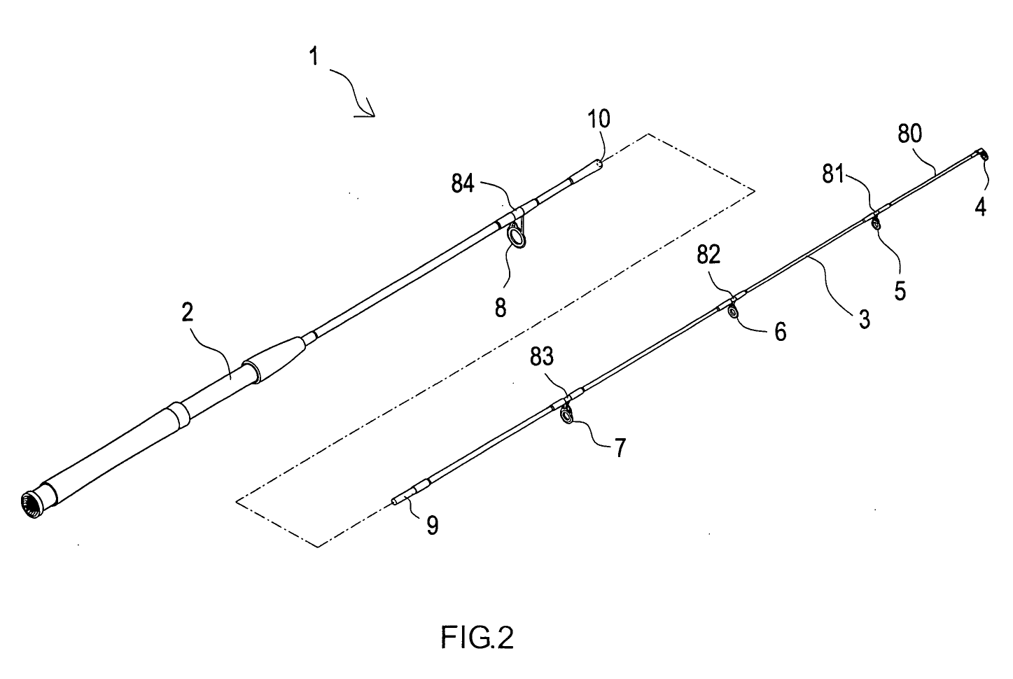

Referring to FIGS. 1 and 2, which show the present invention constructed to include a hand grip 2, a male ferrule 9, a female ferrule 10, a line-support rod 3, five guide rings 4, 5, 6, 7, 8, and five light-emitting areas 80, 81, 82, 83, and 84.

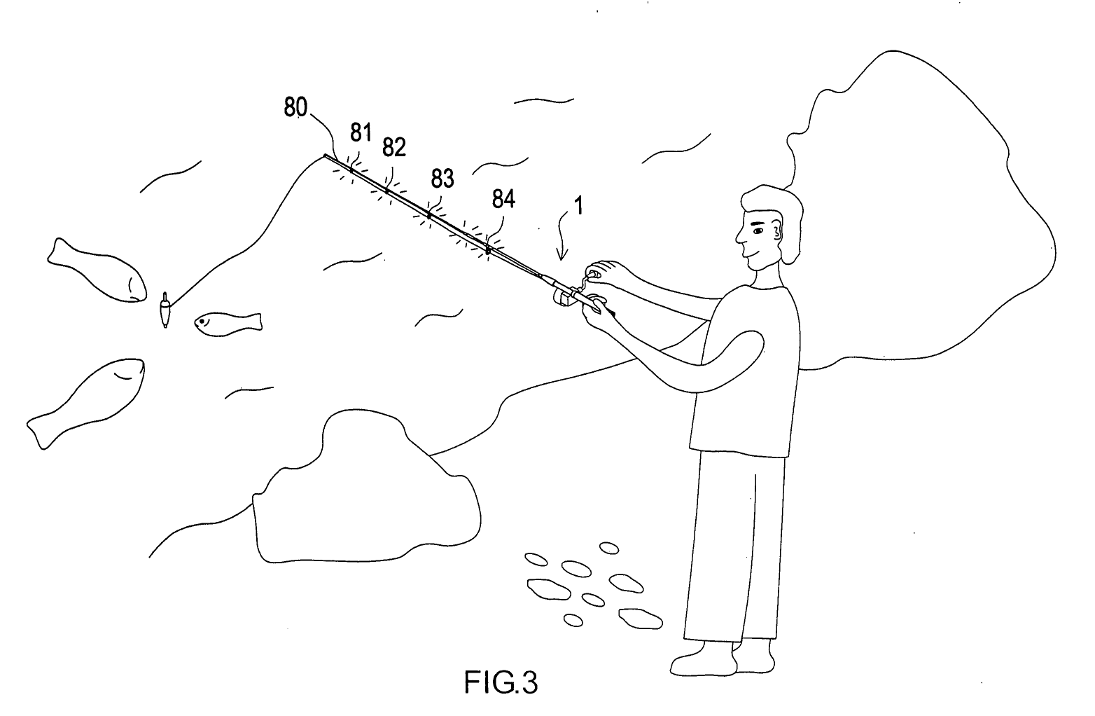

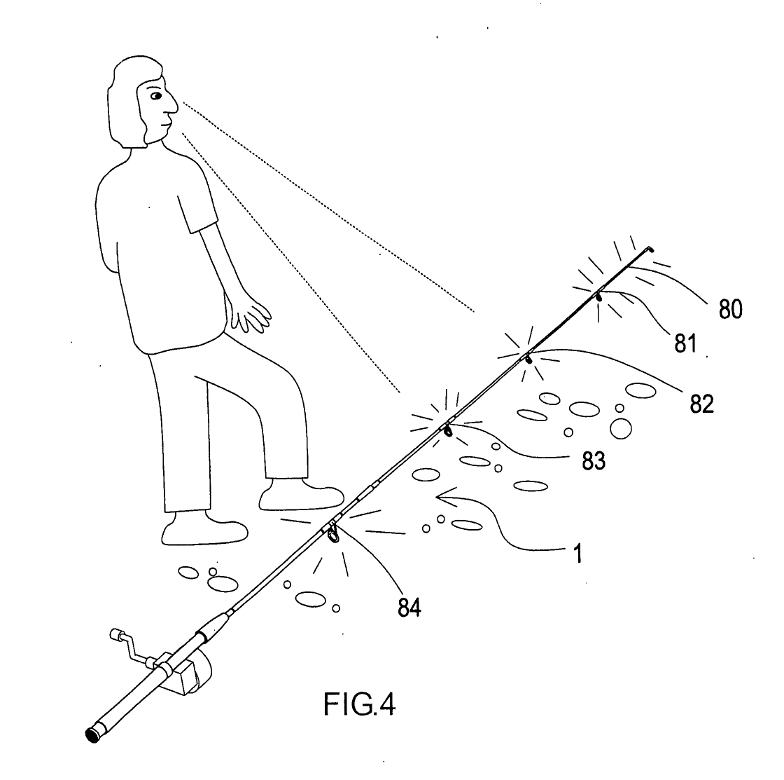

Among which, the guide ring 8 is extendedly configured on a frontal section of the hand grip 2 thereof, and the female ferrule 10 is configured on a frontal end of the guide ring 8. The line-support rod 3 is configured on a head extremity of the female ferrule 10, whereby the male ferrule is extendedly configured on a tail extremity of the line-support rod 3, and thereby achieving assemblage of the female ferrule 10 connecting with the male ferrule 9 of the tail extremity of the line-support rod 3. The four guide rings 4, 5, 6, and 7 are evenly configured along a length of the line-support rod 3 thereon. Furthermore, the light-emitting areas 80, 81, 82, 83, and 84 are configured on the fishing rod 1 to correspond with each of the five guide rings 4, 5, 6, 7, and 8 of the line-support rod 3 and hand grip 2 respectively, thereby, illumination from the five light-emitting areas 80, 81, 82, 83, and 84 achieves effectiveness of allowing identification of the fishing rod 1 when in usage for nighttime fishing. Fluorescent paint is adhered to an external edge of each of the five light-emitting areas 80, 81, 82, 83, and 84. After the fluorescent paint has absorbed light during daytime, the five light-emitting areas 80, 81, 82, 83, and 84 are thereby provided with a property of strong light-emitting brightness and a light-emitting time of 8 hours, therefore achieving functionality of accurate identification of the fishing rod 1 when in usage at nighttime and extended light-emitting usage over a long period of time (see FIG. 3). Moreover, the fishing rod 1 eliminates a need for complicated light-emitting accessories, therefore, saving time and providing convenience of usage. Upon the fishing rod 1 being placed in a location lacking light, light-emitting effectiveness of the light-emitting paint is enabled to provide passers by with a clear view of the fishing rod 1, thereby averting a situation whereby a passer by mistakenly tramples on and damages the fishing rod 1 thereof (see FIG. 4). The present invention is assuredly provided with practicability, is cost-effective, and an advancement of prior art.

In order to highlight advancement and practicability of the present invention, a comparative analysis with a conventional fishing rod is disclosed hereinafter.

Shortcomings of the conventional fishing rod:

1. Light-emitting accessories are structurally complicated or require frequent replacement and adjustment, and thus assembling such is time consuming and multifarious, as well as requiring a need for additional expense for purchase of such.

2. Effective light-emitting time for the appended light-emitting accessories is comparatively short, thus requiring frequent replacement, and thereby extremely troublesome and wasteful.

3. Light-emitting Brightness is comparatively weak, and thus unable to provide functionality of accurate identification.

4. Devoid of practicability.

5. Devoid of advancement.

6. Lacking industrial competitiveness.

### ADVANTAGES OF THE PRESENT INVENTION

1. After the fluorescent paint is adhered to the fishing rod 1 and has absorbed light during daytime, the fishing rod 1 is thereby enabled to emit light at nighttime without requirement for complicated light-emitting accessories, and thus saves time and provides convenience of usage.

2. Having property of strong light-emitting brightness, and a light-emitting time period of 8 hours, thereby achieving functionality of accurate identification and long time usage.

3. Upon the fishing rod being placed in a location lacking light, light-emitting effectiveness of the light-emitting paint is enabled to provide passers by with a clear view of the fishing rod, thereby averting a situation whereby a passer by mistakenly tramples on and damages the fishing rod.

4. Provided with practicability.

5. Provided with advancement.

6. Provided with beneficial advantage to industrial and commercial circles.

In conclusion, the present invention has made a breakthrough in prior art skills, and assuredly has achieved expected functionality of advancement, as well as providing an easily understood disclosure for those not acquainted with technical skills as related to the present invention. Furthermore, the present invention has not been made public prior to this patent application. Advancement and practicability of the present invention clearly comply with conditions for applying for a new model patent. Accordingly, a patent application is proposed herein

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A fishing rod for nighttime fishing usage comprising a hand grip, a male ferrule, a female ferrule, a line-support rod, a plurality of guide rings, and a plurality of light-emitting areas;
wherein one guide ring is extendedly configured on a frontal section of the hand grip thereof, one female ferrule is configured on a frontal end of the guide ring, the line-support rod is configured on a head extremity of the female ferrule, whereby the male ferrule is extendedly configured on a tail extremity of the line-support rod 3, and thereby achieving assemblage of the female ferrule connecting with the male ferrule of the tail extremity of the line-support rod, a number of guide rings are evenly configured along a length of the line-support rod thereon, and the light-emitting areas are configured on the fishing rod to correspond with each of the guide rings of the line-support rod and hand grip respectively, thereby, illumination from the five light-emitting areas achieves effectiveness of allowing identification of the fishing rod when in usage for nighttime fishing; and further characterized in having fluorescent paint adhered to an external edge of each of the light-emitting areas, such that after the fluorescent paint has absorbed light during daytime, the light-emitting areas are thereby provided with a property of strong light-emitting brightness and a light-emitting time of 8 hours, therefore achieving functionality of accurate identification of the fishing rod when in usage at nighttime and extended light-emitting usage over a long period of time, while eliminating a need for complicated light-emitting accessories, therefore, saving time and providing convenience of usage.
